(19) United States
(12) Patent Application Publication
(10) Pub. No.: US 2004/0176535 A1
(43) Pub. Date: Sep. 9, 2004

(54) Polymeric composition based on PVA

(75) Inventors: Hans-Ullrich Huth, Egelsbach (DE); Heinz Jorg Rath, Waldaschaff (DE)

Correspondence Address: Clariant Corporation, Industrial Property Department, 4000 Monroe Road, Charlotte, NC, 28205, US

(73) Assignee: Clariant GmbH

(21) Appl. No.: 10/791,577

(22) Filed: Mar. 2, 2004

(30) Foreign Application Priority Data
Mar. 3, 2003 (DE) 10309064.9

(51) Int. Cl. C08F 16/06

(52) U.S. Cl. 525/56

(57) ABSTRACT

A polymeric composition based on PVA is claimed and is substantively composed of

a) from 50 to 99.9% by weight of polyvinyl alcohol with an average MW of from 5 000 to 25 000 and with a degree of hydrolysis of from 79 to 99.9 mol %, where the polyvinyl alcohol may contain carboxy groups or polyglycol units in the molecule, and

b) from 0.1 to 50% by weight, preferably from 0.1 to 15% by weight, and particularly preferably from 0.1 to 10% by weight, of one or more polysaccharides of the formula

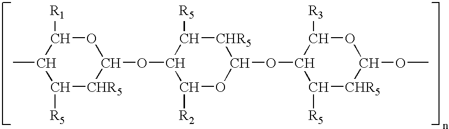

where

R₁, R₂, R₃ are H, CH₂OH, COOMe, COOMe, COOR₄, CONHR₆, or CH₂OSO₃Me, and Me is Na, K, NH₄, Mg, or Ca,

n is a number from 20 to 20 000, preferably from 100 to 10 000, in particular from 1 000 to 9 000,

R₄ is C₁-C₄-alkyl, preferably methyl,

R₅ is OH, NHCOCH₃, H or OCOCH₃ and

R₆ is H, COCH₃, or C₁-C₄, preferably methyl.

This polymeric composition is suitable for producing capsules.

It is known that hard or soft capsules can be produced from gelatin. Gelatin is a peptide mixture with broad molecular weight distribution, formed by cleavage or crosslinking from tropocollagen and, respectively, collagen. Because of the source, the non-sterile preparation process, and the fact that when gelatin is heated to 120° C. it changes its chemical properties irreversibly, it is always likely that microbes (bacteria, yeasts, molds) will be present.

This risk of infection by disease-causing microbes (e.g. BSE) means that there has been no lack of attempts to use other naturally occurring or industrial products, e.g. agar agar, carrageen, carubin, guaran, gum arabic, or cellulose ethers, to replace gelatin.

Polyvinyl alcohol (PVA) is an alternate product having many important properties close to those of gelatin. Furthermore, the toxicological properties and biodegradability of PVA are superior to those of most synthetic polymers. In terms of ease of preparation and price, PVA has the advantage over gelatin of a wide range of molecular weight (MW) and degree of hydrolysis (DH), and the capability of the product to be sterilized in the form either of granular material or of a solution, thus making it free from disease-causing organisms.

A disadvantage of PVA when compared with gelatin is the lower hardness and stiffness of foils, greater extensibility, and also inadequate gel strength (bloom value) for replacement of gelatin by this raw material in the normal production process for hard and soft capsules without major change of mixing specification.

It has now been found that a mixture composed of polyvinyl alcohols and of polymeric uronic acids, or of derivatives of these, is very advantageously suitable for the production of hard and soft capsules.

The invention provides a polymeric composition based on PVA, substantively composed of

a) from 50 to 99.9% by weight of polyvinyl alcohol with an average MW of from 5 000 to 25 000, preferably from 10 000 to 150 000, and particularly preferably from 15 000 to 100 000, and with a degree of hydrolysis of from 79 to 99.9 mol %, preferably from 82 to 99.9 mol %, particularly preferably from 80 to 85, 86 to 89, and 97 to 99.9 mol %, where the polyvinyl alcohol may contain carboxy groups or polyglycol units in the molecule, and

b) from 0.1 to 50% by weight, preferably from 0.1 to 15% by weight, and particularly preferably from 0.1 to 10% by weight, of one or more polysaccharides of the formula

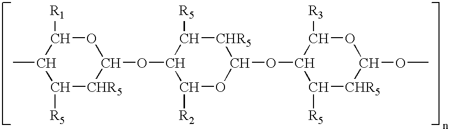

where

R₁, R₂, R₃ are H, CH₂OH, COOMe, COOMe, COOR₄, CONHR₆, or CH₂OSO₃Me,

and Me is Na, K, NH₄, Mg, or Ca,

n is a number from 20 to 20 000, preferably from 100 to 10 000, in particular from 1 000 to 9 000,

R₄ is C₁-C₄-alkyl, preferably methyl,

R₅ is OH, NHCOCH₃, H or OCOCH₃ and

R₆ is H, COCH₃, or C₁-C₄, preferably methyl.

The inventive polymeric composition may also comprise from 0 to 0.5% by weight, preferably from 0.01 to 0.3% by weight, of antifoam, and from 0 to 10% by weight, preferably from 0.01 to 5% by weight, of a surface-active compound, preferably compounds approved for use in cosmetic and pharmaceutical products, e.g. lecithin, glycerol monoesters, or glycerol diesters. Other possible additives are hydrophobicizing oils, among these being hydrophobicizing vegetable oils, and waxes, e.g. groundnut oil, hydrogenated vegetable oil, cocoa butter, shea butter, or beeswax, the amount being from 0 to 10% by weight, preferably from 0.0001 to 2% by weight, modifiers or antiflow agents suitable for better dissolution, of reducing transparency of the capsules, and coloring the same, e.g. silica, iron oxide, calcium oxide, or talc, the amount being from 0 to 3% by weight, preferably from 0.1 to 3% by weight, and also conventional plasticizers, e.g. polyhydric alcohols, such as polyethylene glycol, glycerol, sorbitol, the amount being from 0 to 30% by weight.

When the inventive composition is prepared, the necessary amount of all of the abovementioned raw materials are dissolved in succession in water, with stirring at an elevated temperature, preferably at from 40 to 90° C., and during this process care should be taken that each individual compound has been completely dissolved before the next compound follows. The finished solution may then be sterilized for 30 minutes in an autoclave, and is then free from microbes.

The procedure is preferably as follows:

Before the heating of the water begins, the desired amount of polysaccharide is added by sprinkling, with adequate stirring. The water is then heated to the temperature needed for the dissolution process, mostly from 80 to 90° C., and the weighed-out amount of polyvinyl alcohol is then added, followed shortly by the remaining constituents, and finally the antifoam, at which time the stirrer rotation rate is reduced, and the mixture is then cooled.

The resultant polymeric compositions have good suitability for the production of water-soluble films, and in particular for water-soluble capsules which, by way of example, comprise pharmaceutical active ingredients or active ingredients of some other type.

The examples below are intended to illustrate the invention, but not to limit the same.

### EXAMPLE 1

After heating, 180 g of water are used to solvate 4 g of pectin (20%, based on solids (S)), with vigorous stirring, and 16 g of PVA with an average MW of 30 000 and an average degree of hydrolysis of 98 mol % (Mowiol® 4-98) are added by sprinkling in such a way that no clumping of the grains occurs. Once an almost clear solution had been obtained, 0.4 g of Lecithin 63% was added as emulsifier, and 0.1 g of C₁₀/C₂₋₂ alcohol EO/PO adduct (Genapol® 2822) was added as antifoam. When all of the material had been dissolved, the mixture was allowed to cool. This gave a solution with solids content 9.9% by weight and a viscosity of 836 mPas at 20° C. in a Brookfield LVT viscometer (3/30).

### EXAMPLE 2

6 g of gum arabic (30%, based on S) were dissolved in 180 g of water, with vigorous stirring and heating, and then 14 g of PVA with an average MW of 31 000 and an average degree of hydrolysis of 88 mol % (Mowiol® 4-88) were added by sprinkling in such a way that no clumping of the grains occurred. Once an almost clear solution had been obtained, 0.5 g of CaCO₃, 2 g of shea butter and 0.9 g of Lamepon S (Spinnrad) were then added individually, in each case after dissolution or dispersion of the previous substance. Once the foam had collapsed, the mixture was cooled. The slightly cloudy solution has 8.6% solids and a viscosity of 640 mPas at 20° C. in a Brookfield LVT viscometer (3/30).

### EXAMPLE 3

180 g of water were heated, and used to solvate 1 g of sodium acid alginate (5%, based on S), with vigorous stirring. 19 g of PVA with an average MW of 47 000 and an average degree of hydrolysis of 98 mol % (Mowiol 6-98) were then added by sprinkling in such a way that no clumping of the grains occurred. Once an almost clear solution had been obtained, the mixture was cooled, and then water was added to replace that which had evaporated. The final, slightly foaming solution had a pale brown color and a solids content of 9.9%. The Brookfield LVT (3/60) viscosity measured at 20° C. was 240 mPas.

### EXAMPLE 4

180 g of water were heated, and 2 g of pectin (10%, based on S) were added, with vigorous stirring. Once an almost clear solution had been obtained, 18 g of PVA with an average MW of 150 000 and an average degree of hydrolysis of 88 mol % (Mowiol 23-88) were added by sprinkling in such a way that no clumping of the grains occurred. Once the material had been dissolved, 0.4 g of Lamepon (Spinnrad) was added as emulsifier. After cooling, water was added to replace that which had evaporated. The solution had a solids content of 10% by weight, and gave a viscosity of 940 mPas at 20° C. in a Brookfield LVT viscometer (3/30).

### EXAMPLE 5 (COMPARATIVE EXAMPLE)

The procedure was as described in example 1, taking 160 g of water and 40 g of PVA, but omitting pectin, emulsifier, and antifoam, the result being a 20.6% colorless, clear solution and a viscosity of about 1 620 mPas at 20° C., using a Brookfield LVT viscometer (3/30).

The solids content of all of the solutions prepared in 1-5 were adjusted to 10% by weight. The solutions were applied to a polyester foil, using a 1 500 u doctor, and dried in a dust-free atmosphere at room temperature for 3 days. Square sections of dimensions 6×6 cm were then cut out from this material and clamped into a metal frame. The metal frames were suspended, at varying temperature, in a 500 ml glass beaker with water and thermometer, the magnetic stirrer being used for agitation at moderate speed. The time required for the polymer foil to dissolve or break up was then determined.

Result:

Dissolution time for the polymeric compositions of examples 1 to 5 in minutes

| | Example | Example | Example | Example | Example |
|---|---|---|---|---|---|
| | 1 | 2 | 3 | 4 | 5 |
| Tem- | Foil | Foil | Foil breaks | Foil | Insoluble, |
| perature | breaks up | dissolves | apart into | dissolves | foil cracks |
| 40° C. | after | after | large pieces | after | after |
| | 6 min. | 1 min. | after 6 min. | 40 sec. | 25 min. |
| Tem- | Foil | Foil | Foil breaks | Foil | Insoluble, |
| perature | breaks | dissolves | up, and | dissolves | foil cracks |
| 60° C. | up after | after | dissolves after | after | after |
| | 36 min. | 1 min. | 3 min. | 3 sec. | 18 min. |

Test specimens for determining ultimate tensile strength to DIN ISO 527 were stamped out from the same films, and stored for 7 days at 23° C. and 50% rel. humidity. Ultimate tensile strength was then determined at 300 mm/min. separation velocity.

Result:

Ultimate tensile strength for the polymeric compositions of examples 1 to 5:

| Example 1 | Example 2 | Example 3 | Example 4 | Example 5 |
|---|---|---|---|---|
| 73.8 | 16.0 | 39.8 | 78.4 | 24.2 |

1. A polymeric composition based on PVA, substantively composed of
a) from 50 to 99.9% by weight of polyvinyl alcohol with an average MW of from 5 000 to 25 000 and with a degree of hydrolysis of from 79 to 99.9 mol %, where the polyvinyl alcohol may contain carboxy groups or polyglycol units in the molecule, and
b) from 0.1 to 50% by weight, preferably from 0.1 to 15% by weight, and particularly preferably from 0.1 to 10% by weight, of one or more polysaccharides of the formula 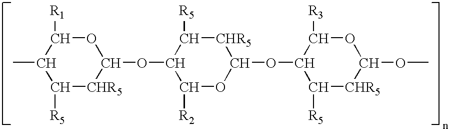
where
R₁, R₂, R₃ are H, CH₂OH, COOMe, COOMe, COOR₄, CONHR₆, or CH₂OSO₃Me,
and Me is Na, K, NH₄, Mg, or Ca,
n is a number from 20 to 20 000, preferably from 100 to 10 000, in particular from 1 000 to 9 000,
R₄ is C₁-C₄-alkyl, preferably methyl,
R₅ is OH, NHCOCH₃, H or OCOCH₃ and
R₆ is H, COCH₃, or C₁-C₄, preferably methyl.

2. The polymeric composition as claimed in claim 1, which also comprises from 0 to 5% by weight of antifoam.

3. The polymeric composition as claimed in claim 1, which also comprises from 0 to 10% by weight of a surface-active compound.

4. The polymeric composition as claimed in claim 1, which comprises from 0 to 10% by weight of hydrophobicizing oils.

5. The polymeric composition as claimed in claim 1, which comprises from 0 to 3% by weight of modifiers or antiflow additives.

6. The polymeric composition as claimed in claim 1, which comprises from 0 to 30% by weight of plasticizer.

7. The use of the polymeric composition as claimed in claim 1 for producing water-insoluble capsules or films.
